(19) United States
(12) Patent Application Publication
(10) Pub. No.: US 2024/0412269 A1
(43) Pub. Date: Dec. 12, 2024

(54) DECENTRALIZED NETWORK FOR SEARCH FOR VEHICLES

(71) Applicant: Capital One Services, LLC, Mclean, VA (US)

(72) Inventors: Geoffrey DAGLEY, Mckinney, TX (US); Babu MANNAR, Little Elm, TX (US); Derek BUMPAS, Allen, TX (US); Adam GERNES, Plano, TX (US)

(73) Assignee: Capital One Services, LLC, McLean, VA (US)

(21) Appl. No.: 18/206,768

(22) Filed: Jun. 7, 2023

(51) Int. Cl. G06Q 30/0601

(52) U.S. Cl. CPC G06Q 30/0627; G06Q 30/0641

(57) ABSTRACT

A system and method that facilitates a decentralized search is disclosed. The system can receive, from a client device, a search request for information about a vehicle. The search request may be transmitted to decentralized entities to retrieve the information about the vehicle. The system can receive from the decentralized entities or a subset of decentralized entities, information about the vehicle. A graphical user interface (GUI) may be generated with the information about the vehicle. The GUI may be transmitted to the client device for display

### TECHNICAL FIELD

Aspects relate to a system that uses a decentralized architecture to search for and retrieve data.

### BACKGROUND

Conventional systems and methods of searching for vehicles listed for sale typically require having a user log onto a software application or browse to a website listing vehicles for sale. The user can then perform a search for vehicles using the software application or website. The user can further filter the search using any number of vehicle related features (e.g., colors, trims, packages, etc.). Typically, the software application or website stores the vehicle listings data in a central database or repository. The central database or repository may be populated with listings obtained from vehicle dealerships. The vehicle dealerships provide data related to vehicles they have for sale. Typically, this data is provided to the central database or repository via application programming interfaces (APIs) or spreadsheets, and uploaded into the central database or repository periodically.

This approach has at least two shortcomings. First, a full inventory of all vehicles listed for sale can never be obtained because it is impossible to have a single database or repository of every dealer's vehicles. Thus, any central repository will not have a full range of vehicles for sale, and the user likely has to execute searches for vehicles on multiple websites or use different software applications to search for vehicles. Second, the central database or repository can never be fully up to date. This is because the listings populating the central database or repository depend on the frequency at which the vehicle dealerships update their data. Often, there is some lag time between when vehicle dealerships update their inventory and push it to the central database or repository. Thus, the software application or website listings may not reflect the most up to date inventory of vehicles that the vehicle dealerships have for sale. Moreover, if there are errors in the data provided, incorrect listings will also be displayed, which is undesirable. Thus, what is needed is systems and methods to overcome the aforementioned limitations.

### SUMMARY

Aspects of this disclosure are directed to a system and methods that use a decentralized architecture to search for and retrieve data. The system and methods are described with respect to searches for a vehicle listed for sale. The vehicle may be a car, motorcycle, boat, bicycle, or other vehicle type listed for sale. While discussed in the context of vehicles (particularly cars), the system and methods may be used for any other tangible/physical good.

In aspects, the system can perform the decentralized search by first receiving, from a client device, a search request for information about a vehicle listed for sale. The search may be initiated by a potential buyer looking to purchase a vehicle. The search may be initiated using a software application installed on the client device. For example, the software application may be a mobile application, web based application, or a desktop application. The software application can also be installed on a browser, which can also be installed on the client device. If installed on the browser, the software application can take the form of an applet, plugin, etc.

In aspects, once the search request is received, the system can transmit the search request to decentralized entities to retrieve the information about the vehicle. The information can include information about vehicles listed for sale such as the makes and models of those vehicles, the trim of the vehicles, the features of the vehicles, what dealership is selling the vehicles, etc. The decentralized entities can take different forms. For example, the decentralized entities may be a human, a robot, an autonomous vehicle, an aerial drone, a database, etc. The decentralized entities can perform physical searches of physical locations (e.g., vehicle dealership lots) or can perform computerized searches (e.g., searching a database) and return results indicating what vehicles are available for sale and from which dealerships. In aspects, the decentralized entities or a subset of the decentralized entities can perform a search based on the search request and return the search results to the potential buyer and/or the client device.

The decentralized entities or a subset thereof can perform the search in a variety of ways as will be discussed further below with respect to the various aspects of the disclosure. Thus, the system can receive from the decentralized entities or a subset of decentralized entities, sale related information about a vehicle type that the potential buyer is searching for. In aspects, once received, the system can generate a graphical user interface (GUI) with the information about the vehicle and transmit the GUI to the client device for display. The GUI can display the information about the vehicle and information related to the entity/dealer selling the vehicle.

In aspects, the information received from the decentralized entities or a subset of decentralized entities may be received asynchronously. That is, the information received can come in separately and over a period of time from each of the decentralized entities. In aspects, the information received from the decentralized entities may be received in real-time from when the search request is initiated. Real-time refers to a time within seconds or milliseconds from when the search request is initiated. Whether the information received is received asynchronously or in real-time depends on the type of decentralized entity used and how it searches for the vehicles.

In aspects, the search request may be queued prior to being transmitted to the decentralized entities. The queue can enable the search request to persist for a period of time so that each of the decentralized entities has an opportunity to process the request and execute the request. In aspects, the information received from the decentralized entities or the subset of the decentralized entities can also be queued prior to generating the GUI with the information. In this way, the information received may be held for a period of time so that a complete set of data may be received by the system prior to generating the GUI with the information and presenting that information to the user. The queuing also allows for asynchronously received data to be collected so that it may be presented all together rather than piecemeal. Thus, the queue allows the information received to be batch processed and presented.

The system is unique in that its decentralized architecture provides a novel way to search for vehicles. The system combines both physical searches and computerized searches and aggregates the results of each to provide an up to date set of results about what entities/dealerships have what vehicles for sale. This is different from conventional systems, because conventional systems do not offer the combination of physical searches in combination with computerized searches for vehicles for sale. Conventional systems typically search for vehicles listed in a central database or repository and return results for vehicles listed for sale based on the information contained in the central database or repository.

The decentralized architecture overcomes the shortcomings of conventional systems in several ways. First, the system allows for the most up to date inventory of vehicles available for sale to be presented to a user. This is because the searches for vehicles are done on demand as a result of the search request, and physical searches in addition to computerized searches are performed. Thus, rather than solely relying on dealership provided data, the system is proactive in collecting data, through the use of decentralized entities proactively retrieving the data, from for example dealership lots, etc. Second, the decentralized architecture can allow for an expanded set of data to be gathered. This is because rather than merely relying on dealerships to provide vehicle information, the system can use decentralized entities such as robots and aerial drones to proactively go to dealership lots, scan their inventories, and return their results without the dealership having to provide any data.

The decentralized architecture also provides a new paradigm for searches because it does not attempt to aggregate information into a central database or repository. Rather, the system allows the decentralized entities to search for the data requested directly from the physical locations, computers, databases, dealerships, etc. that are selling the vehicles. In this way, the physical locations, computers, databases, dealerships, etc. can each form individual “databases” from which the information about vehicles for sale may be retrieved. As a result, inventory data may be obtained directly from the physical locations, computers, databases, dealerships, etc. directly rather than a centralized database or repository with aggregated inventory data for vehicles for sale.

The architecture has several benefits. First, because the system allows inventory data to be obtained directly from the source of data without relying on the source of data to provide the inventory data, a more accurate set of results may be obtained indicating what vehicles are for sale and by what entities. Second, the architecture allows for a wider range of data to be accumulated regarding what vehicles are for sale and from what vehicle dealerships. Because the decentralized entities may be robots or aerial drones, they may be dispatched to various vehicle dealerships to scan vehicles on the lots of those dealerships matching those requested by the user from the search request. These robots or aerial drones may be dispatched to any number of vehicle dealerships. In aspects, the dealerships themselves can integrate into the system and can request that these robots or aerial drones scan their lots upon the system receiving the search request. This way, the vehicle dealerships can relieve themselves of having to constantly keep an updated list of vehicles available for sale to provide to websites listing their vehicles for sale.

Certain aspects of the disclosure have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the art to make and use the aspects.

FIG. 1 is an example architecture of a system that can perform a decentralized search for a vehicle listed for sale, according to aspects of the disclosure.

FIG. 2 is an example graphical user interface (GUI) showing the results of the decentralized search, according to aspects of the disclosure.

FIG. 3 is an example method of operating the system, according to aspects of the disclosure.

FIG. 4 is an example architecture of components for devices that may be used to implement the system, according to aspects of the disclosure.

In the drawings, like reference numbers generally indicate identical or similar elements. Additionally, generally, the left-most digit(s) of a reference number identifies the drawing in which the reference number first appears.

### DETAILED DESCRIPTION

The following aspects are described in sufficient detail to enable those skilled in the art to make and use the disclosure. It is to be understood that other aspects are evident based on the present disclosure, and that system, process, or mechanical changes may be made without departing from the scope of aspects of the present disclosure.

In the following description, numerous specific details are given to provide a thorough understanding of aspects. However, it will be apparent that aspects may be practiced without these specific details. To avoid obscuring an aspect, some well-known circuits, system configurations, and process steps are not disclosed in detail.

The drawings showing aspects of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the system may be operated in any orientation.

Certain aspects have other steps or elements in addition to or in place of those mentioned. The steps or elements will become apparent to those skilled in the art from a reading of the following detailed description when taken with reference to the accompanying drawings.

### System Overview and Function

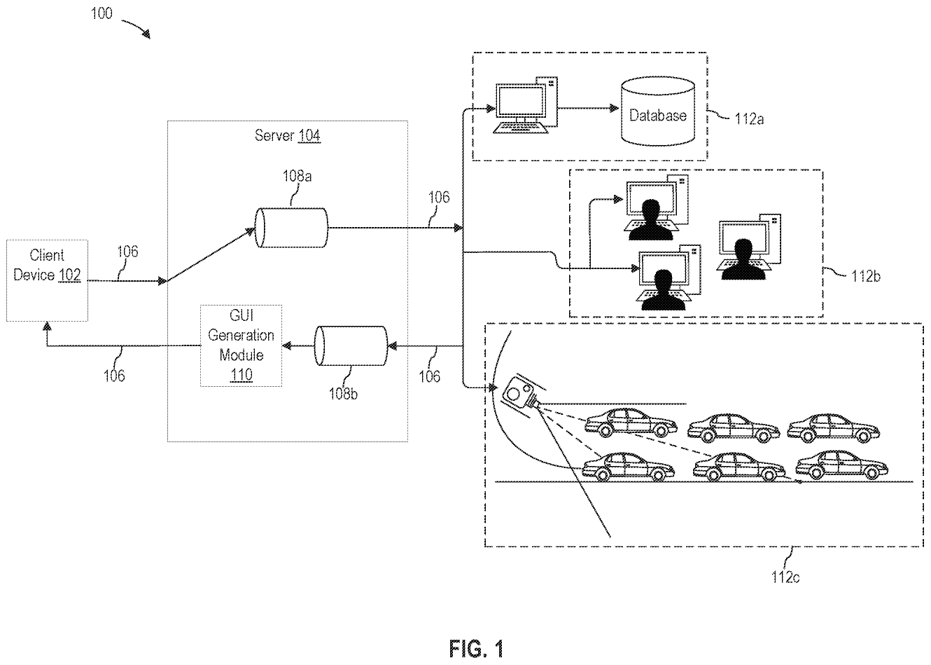

FIG. 1 is an example architecture of a system 100 that can perform a decentralized search for a vehicle listed for sale, according to aspects of the disclosure. In aspects, the system 100 can perform the decentralized search by first receiving, from a client device 102, a search request for information about a vehicle listed for sale. The search request can take the form of a text search where the user types in a make and/or model of a vehicle he or she is interested in purchasing. In aspects, the search request may be typed into a textbox. In aspects, in conjunction or separately from the typed search, the search request may be done via drop down menus in which the user can select from vehicle makes and models.

In aspects, the search may be initiated using a software application installed on the client device 102. For example, the software application may be a mobile application or a desktop application, or a platform such as Capital One's AutoNavigator™ platform. The software application can also be installed on a browser, which can also be installed on the client device 102. If installed on the browser, the software application can take the form of an applet, plugin, etc. The client device 102 may be any of a variety of devices, such as a smart phone, a cellular phone, a personal digital assistant, a tablet computer, a notebook computer, a laptop computer, a desktop computer, or a combination thereof.

In aspects, the search request may be transmitted to backend components of the system 100 for further processing. In aspects, the backend components may be installed on a server 104. In aspects, the server 104 may be a variety of centralized or decentralized computing devices. For example, the server 104 may be a mobile device, a laptop computer, a desktop computer, grid-computing resources, a virtualized computing resource, cloud-computing resources, peer-to-peer distributed computing devices, a server farm, or a combination thereof. The server 104 may be centralized in a single room, distributed across different rooms, distributed across different geographic locations, or embedded within a network 106. The server 104 can couple with the network 106 to communicate with other devices, such as the client device 102. The server 104 and the client device 102 may be stand-alone devices and work independently from one another.

The network 106 refers to a telecommunications network, such as a wired or wireless network. The network 106 can span and represent a variety of networks and network topologies. For example, the network 106 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 106. Cable, Ethernet, digital subscriber line (DSL), fiber optic lines, fiber to the home (FTTH), and plain old telephone service (POTS) are examples of wired communication that may be included in the network 106. Further, the network 106 can traverse a number of topologies and distances. For example, the network 106 can include a direct connection, personal area network (PAN), local area network (LAN), metropolitan area network (MAN), wide area network (WAN), or a combination thereof.

In aspects, the search request may be received at the server 104 and put into a queue 108a. The queue 108a refers to a data structure in which search requests are maintained in a sequence and may be modified by the addition of search requests at one end of the sequence and the removal of search requests from the other end of the sequence. In aspects, the queue 108a allows the system 100 to accumulate different search requests, and maintain these search requests for a period of time so that decentralized entities 112 have an opportunity to process the request and execute the request. The queue 108a also allows the system to prioritize search requests and allows the decentralized entities 112 to obtain information in response to the search requests based on the order in which the search requests were received.

The decentralized entities 112 refer to humans, computers, or robots that may be used to gather information based on the search requests. The decentralized entities 112 can take different forms. For example, the decentralized entities 112 may be a human, a robot, an autonomous vehicle, an aerial drone, a database, a computer, etc. The decentralized entities 112 can perform physical searches of physical locations (e.g., vehicle dealership lots) or can perform computerized searches (e.g., searching a database) and return results in response to the search requests. Thus, if the search request is requesting information about a particular vehicle make or model for sale, the decentralized entities 112 may be dispatched to perform a search for which dealerships are selling that particular vehicle make or model. In aspects, the decentralized entities 112 or a subset of the decentralized entities can perform the search based on the search request and return the search results to the potential buyer and/or the client device 102.

In FIG. 1, the decentralized entities 112 are shown as {112a, 112b, 112c} representing different types of decentralized entities 112. Decentralized entity 112a shows a computer and database which may be searched for vehicle listings. Decentralized entity 112a is representative of a more traditional search approaches for vehicle searches, in which a search request for a particular vehicle is made by a user, and a database or repository having an inventory showing what dealerships are selling the vehicle is searched. However, different from traditional models, the decentralized entity 112a may or may not be a database operated by the company or institution implementing the system 100.

Decentralized entity 112b shows humans that may be dispatched to search for vehicles based on the search request. In aspects, the humans may be employees of dealerships, or may be individuals independent of dealerships that may be deployed to search for the vehicle based on the search request. In aspects, based on receiving the search request the humans can either search the vehicle lots or may be dispatched to perform searches of databases, repositories, etc. to gather information regarding what dealerships are selling the particular vehicle and report that information back to the system 100.

Decentralized entity 112c shows robots or an aerial drone that may be used to scan vehicle dealership lots for the vehicle based on the search request. For example, these robots or aerial drones can receive the search request and be dispatched to go to vehicle dealerships selling that particular vehicle make and/or model to search for the vehicle and report that information back to the system 100.

In aspects, the decentralized entities 112 can interface with the system 100 using application programming interfaces (APIs) or software applications so that the decentralized entities 112 may be notified of the search requests. For example, computers, databases, robots or aerial drones can interface with the backend components of the system 100 via APIs to receive the search request from the queue 108a. Once received they can process the search request and be dispatched to retrieve information based on the search request. Humans can interface with the backend components of the system 100 using software applications (e.g., mobile applications, desktop applications, web based applications, etc.) to receive the search request via a notification. Once received, the humans may be dispatched to retrieve information based on the search request. In aspects, the notifications can take the form of a push notification, an email, a text message, a phone call, or any other similar notification method. In this way, the search requests containing the specific information requested by a user may be transmitted to the decentralized entities 112 so the decentralized entities 112 can search for vehicles matching the vehicle requested.

In aspects, the decentralized entities 112 can search for the vehicle by either searching databases or physical locations for the vehicles. If searching physical locations, the decentralized entities 112 can perform searches in a variety of ways. For example, a robot, human, or aerial drone can search for vehicles on a vehicle dealership lot by approaching the vehicles matching the vehicle requested by the search request and scanning a QR code, tag, vehicle identification number (VIN), or similar label which may be used to identify the vehicle. For the purposes of this disclosure, it is assumed that once scanned the QR code, tag, VIN, or similar label will result in the identification of the vehicle and the transmittal of information about the vehicle to the decentralized entities 112. Such information may be retrieved from further databases that store information about the vehicle and can identify the scanned QR code, tag, VIN, or similar label and match it to the vehicle information about that vehicle. In aspects, and either in conjunction or separately, the robot, human, or aerial drone can perform an optical scan or image recognition of a vehicle dealership lot to identify vehicles matching the requested vehicle from the search request. Such optical scans or image recognitions can use techniques disclosed in U.S. application Ser. No. 16/128,682, filed on Sep. 12, 2018; U.S. application Ser. No. 16/387,154, filed on Apr. 17, 2019; U.S. application Ser. No. 15/915,329, filed on Mar. 8, 2018; U.S. application Ser. No. 15/915,998, filed on Mar. 8, 2018; U.S. application Ser. No. 15/915,947, filed on Mar. 8, 2018 (all of which are incorporated by reference herein in their entireties), to recognize vehicles matching the vehicle requested from the search request. In aspects, the decentralized entities 112 can use technologies such as RFID technology to recognize the vehicles. For example, RFID chips may be place on each vehicle on the lot identifying the vehicle. The decentralized entities 112 can survey the lot and determine, based on the RFID chips, which vehicles match the vehicle requested from the search request and identify those vehicles. The information about those vehicles can then be obtained, via further databases, and transmitted back to the backend components of the system 100 to be transmitted to the user requesting the information.

In aspects, once the information is obtained regarding the vehicles, the decentralized entities 112 can transmit the information to the backend components of the system 100. In aspects, this information may be sent to a further queue 108b designed to receive the information transmitted from the decentralized entities 112 to the backend components of the system 100. Queue 108b can work in a similar manner as queue 108a, except that it is design to receive information from the decentralized entities 112 rather than transmit information to the decentralized entities 112. In aspects, queue 108b can store the information received for a period of time. In this way, information received from the decentralized entities 112 may be accumulated in the order received so that once a predetermined amount of information is received, it may be batch processed and sent to further components of the system 100 to be processed so that it may be presented to the user who made the search request. Thus, information received from the decentralized entities 112 may be accumulated asynchronously and presented to the users.

In aspects, the queue 108b may be implemented such that it can transmit the information received in real-time and not wait to transmit that information back to other components of the system 100. Thus, search results may be sent to further components of the system 100 as they are received rather than accumulated and batch processed. Such implementations are appropriate when, for example, the decentralized entities are computers or databases that are to be searched, rather than humans, robots, or aerial drones that need to be dispatched before they can generate search results.

In aspects, the queue 108b can transmit the search results it receives to further components of the system 100. Such components can include a GUI generation module 110. The GUI generation module 110 can enable generating a GUI with the search results received. For example, the GUI generation module 110 can generate a screen, graphics, windows, etc. displaying the results of the search. In aspects, the display can display a picture of the vehicle found matching the vehicle requested in the search request. The display can also display the name of the vehicle dealership where the vehicle is located, a contact information of the dealership, the price of the vehicle that the vehicle is being offered at, the mileage of the vehicle, and any other pertinent information related to the vehicle that is relevant in a sales context. A person of ordinary skill in the art (POSA), reading this disclosure, will know what types of information can be displayed.

In aspects, once the GUI generation module 110 generates the GUI, the GUI may be transmitted back to the client device 102 to be displayed to the user on a display of the client device 102. In aspects, the GUI may be displayed on the software application that the user used to make the search request. In aspects, the GUI may be displayed as an email message, a text message, or as part of a link. If sent as part of a link, the link may lead the user to the GUI after it is clicked, so that the user can view the GUI with the search results.

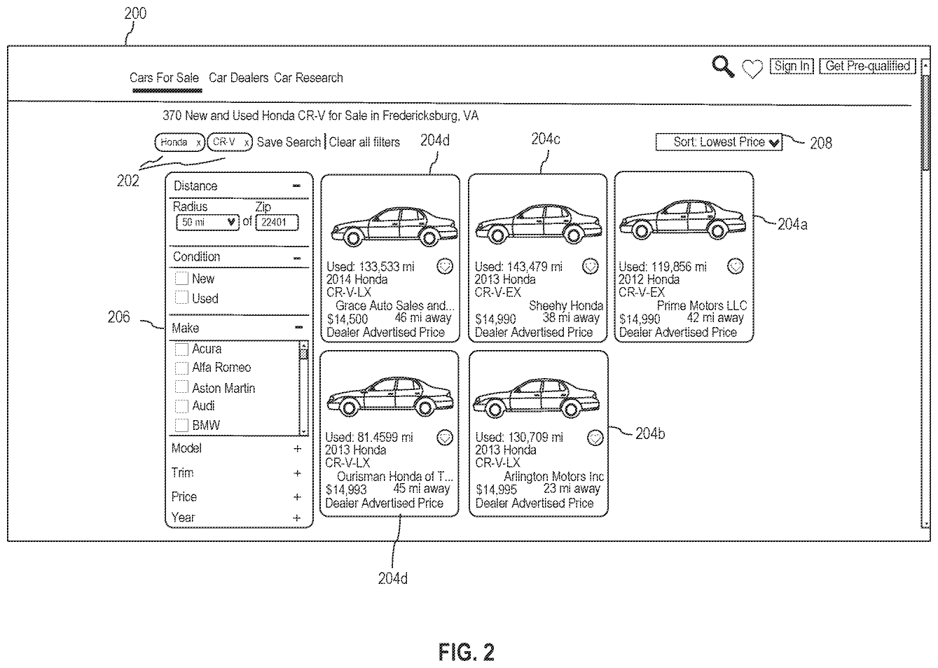

FIG. 2 is an example GUI 200 showing the results of the decentralized search, according to aspects of the disclosure. GUI 200 may be generated by the GUI generation module 110 of FIG. 1. GUI 200 shows a search performed for a user requesting more information about vehicle dealerships that sell a “HONDA CR-V” as shown by indicators 202. In response to the search request, search results 204 are returned. In FIG. 2, four search results 204 are shown as {204a, 204b, 204c, 204d}. This is exemplary, and any number of search results may be returned. In aspects, the search results 204 can display vehicle related information regarding vehicles found by the decentralized entities 112 matching the search request. For example, search results 204 can display the condition of the vehicles found (e.g., new or used), a year of the vehicle, a model and trim of the vehicle, a dealership information indicating which dealership is selling the vehicle, the price of the vehicle, a distance from the user that the dealership is located, etc. In aspects, the user can use a dropdown menu 208 to sort the search results 204. In aspects, the GUI 200 can also have a filter window 206 that may be used to further refine or filter the search results 204. For example, using the filter window 206, the user can further refine the search results 204 to filter for particular trims of the vehicle, limit the dealerships to a particular distance from the user, choose a particular year for the vehicle, choose a price range for the vehicle, etc. A POSA, reading this disclosure, will know what types of information may be displayed in the filter window 206 and what parameters may be used to filter the search results 204.

The modules described in FIGS. 1 and 2 may be implemented as or with instructions stored on a non-transitory computer readable medium to be executed by one or more computing units such as a processor, a special purpose computer, an integrated circuit, integrated circuit cores, or a combination thereof. The non-transitory computer readable medium may be implemented with any number of memory units, such as a volatile memory, a nonvolatile memory, an internal memory, an external memory, or a combination thereof. The non-transitory computer readable medium may be integrated as a part of the system 100 or installed as a removable portion of the system 100.

The system 100 is unique in that its decentralized architecture provides a novel way to search for vehicles. The system 100 combines both physical searches and computerized searches and aggregates the results of each to provide an up to date set of results about what entities have what vehicles for sale. This is different from conventional systems, because conventional systems do not offer the combination of physical searches in combination with computerized searches. Conventional systems typically search for vehicles listed in a central database or repository and return results for vehicles listed for sale.

The decentralized architecture overcomes the shortcomings of conventional systems in several ways. First, the system 100 allows for the most up to date inventory of vehicles available for sale to be presented to a user. This is because the searches for vehicles are done on demand as a result of the search request, and physical searches in addition to computerized searches are performed. Thus, rather than solely relying on dealership provided data, the system 100 is proactive in collecting data itself, through the use of decentralized entities 112 proactively retrieving the data, from for example dealership lots, etc. Second, the decentralized architecture can allow for an expanded set of data to be gathered. This is because rather than merely relying on dealerships to provide vehicle information, the system 100 can use decentralized entities 112, such as robots and aerial drones, to proactively go to dealership lots, scan their inventories, and return their results without the dealership having to provide any data.

The decentralized architecture also provides a new paradigm for searches because it does not attempt to aggregate information into a central database or repository. Rather, the system 100 allows the decentralized entities 112 to search for the data requested directly from the physical locations, computers, databases, dealerships, etc. that are selling the vehicles. In this way, the physical locations, computers, databases, dealerships, etc. can each form individual “databases” from which the information about vehicles for sale may be retrieved. As a result, inventory data may be obtained directly from the physical locations, computers, databases, dealerships, etc. directly rather than a centralized database or repository with aggregated inventory data for vehicles for sale.

The architecture has several benefits. First, because the system 100 allows inventory data to be obtained directly from the source of data without relying on the source of data to provide the inventory data, a more accurate set of results may be obtained indicating what vehicles are for sale and by what entities. Second, the architecture allows for a wider range of data to be accumulated regarding what vehicles are for sale and from what vehicle dealerships. Because the decentralized entities 112 may be robots or aerial drones, they may be dispatched to various vehicle dealerships to scan vehicles on the lots of those dealerships matching those requested by the user from the search request. These robots or aerial drones may be dispatched to any number of vehicle dealerships. In aspects, the dealerships themselves integrate into the system 100 and can request that these robots or aerial drones to scan their lots upon the system receiving the search request. This way, the vehicle dealerships can relieve themselves of having to constantly keep an updated list of vehicles available for sale to provide to websites listing their vehicles for sale.

### Methods of Operation

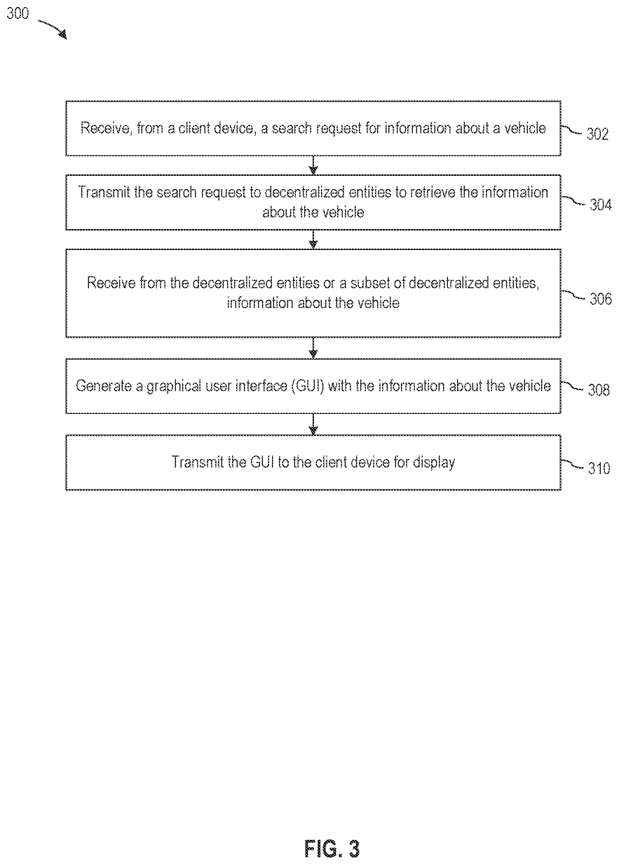

FIG. 3 is an example method 300 of operating the system 100, according to aspects of the disclosure. Method 300 may be performed as a series of steps by a computing unit such as a processor of the client device 102, the server 104, or a combination thereof.

At step 302, the system 100 can receive, from a client device 102, a search request for information about a vehicle. The search may be initiated by a potential buyer looking to purchase a vehicle. The search may be initiated using a software application installed on the client device 102. For example, the software application may be a mobile application, web based application, or a desktop application. The software application can also be installed on a browser, which can also be installed on the client device.

At step 304, the search request may be transmitted to decentralized entities 112 to retrieve the information about the vehicle. The information can include information about vehicles listed for sale such as the makes and models of those vehicles, the trim of the vehicles, the features of the vehicles, what dealership is selling the vehicles, etc. In aspects, the search request may be received at the server 104 and put into a queue 108a. The queue 108a allows the system 100 to accumulate different search requests, and maintain these search requests for a period of time so that decentralized entities 112 have an opportunity to process the request and execute the request. The decentralized entities 112 can perform a physical or computerized search to retrieve information about the vehicle.

At step 306, the system 100 can receive from the decentralized entities 112 or a subset of decentralized entities 112, information about the vehicle. In aspects, the decentralized entities 112 can send that information back to the backend components of the system 100 at the server 104. In aspects, the returned information can be put in a queue 108b.

At step 308 a GUI (e.g., GUI 200) may be generated with the information about the vehicle. The GUI 200 can be a screen, graphics, windows, etc. displaying the results of the search. In aspects, the display can display a picture of the vehicle found matching the vehicle requested in the search request. The display can also display the name of the vehicle dealership where the vehicle is located, a contact information of the dealership, the price of the vehicle that the vehicle is being offered at, the mileage of the vehicle, and any other pertinent information related to the vehicle that is relevant in a sales context. At step 310, the GUI may be transmitted to the client device 102 for display.

The operation of method 300 may be performed, for example, by system 100, in accordance with aspects described above.

### Components of the System

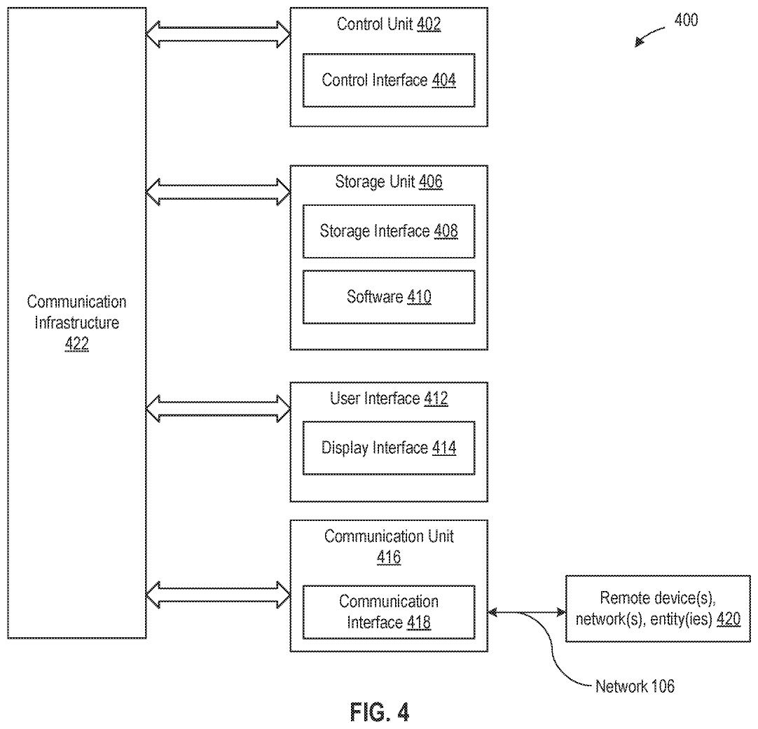

FIG. 4 is an example architecture 400 of components for devices that may be used to implement the system 100, according to aspects of the disclosure. The components may be the components of the server 104 or the client device 102. In aspects, the components may include a control unit 402, a storage unit 406, a communication unit 416, and a user interface 412. The control unit 402 may include a control interface 404. The control unit 402 may execute a software 410 to provide some or all of the intelligence of system 100. The control unit 402 may be implemented in a number of different ways. For example, the control unit 402 may be a processor, an application specific integrated circuit (ASIC), an embedded processor, a microprocessor, a hardware control logic, a hardware finite state machine (FSM), a digital signal processor (DSP), a field programmable gate array (FPGA), or a combination thereof.

The control interface 404 may be used for communication between the control unit 402 and other functional units or devices of system 100. The control interface 404 may also be used for communication that is external to the functional units or devices of system 100. The control interface 404 may receive information from the functional units or devices of system 100, or from remote devices 420, such as databases containing vehicle information, or may transmit information to the functional units or devices of system 100, or to remote devices 420. The remote devices 420 refer to units or devices external to system 100.

The control interface 404 may be implemented in different ways and may include different implementations depending on which functional units or devices of system 100 or remote devices 420 are being interfaced with the control unit 402. For example, the control interface 404 may be implemented with a pressure sensor, an inertial sensor, a microelectromechanical system (MEMS), optical circuitry, waveguides, wireless circuitry, wireline circuitry to attach to a bus, an application programming interface, or a combination thereof. The control interface 404 may be connected to a communication infrastructure 422, such as a bus, to interface with the functional units or devices of system 100 or remote devices 420.

The storage unit 406 may store the software 410. For illustrative purposes, the storage unit 406 is shown as a single element, although it is understood that the storage unit 406 may be a distribution of storage elements. Also for illustrative purposes, the storage unit 406 is shown as a single hierarchy storage system, although it is understood that the storage unit 406 may be in a different configuration. For example, the storage unit 406 may be formed with different storage technologies forming a memory hierarchical system including different levels of caching, main memory, rotating media, or off-line storage. The storage unit 406 may be a volatile memory, a nonvolatile memory, an internal memory, an external memory, or a combination thereof. For example, the storage unit 406 may be a nonvolatile storage such as nonvolatile random access memory (NVRAM), Flash memory, disk storage, or a volatile storage such as static random access memory (SRAM) or dynamic random access memory (DRAM).

The storage unit 406 may include a storage interface 408. The storage interface 408 may be used for communication between the storage unit 406 and other functional units or devices of system 100. The storage interface 408 may also be used for communication that is external to system 100. The storage interface 408 may receive information from the other functional units or devices of system 100 or from remote devices 420, or may transmit information to the other functional units or devices of system 100 or to remote devices 420. The storage interface 408 may include different implementations depending on which functional units or devices of system 100 or remote devices 420 are being interfaced with the storage unit 406. The storage interface 408 may be implemented with technologies and techniques similar to the implementation of the control interface 404.

The communication unit 416 may enable communication to devices, components, modules, or units of system 100 or to remote devices 420. For example, the communication unit 416 may permit the system 100 to communicate between the server 104, the client device 102, and the decentralized entities 112. The communication unit 416 may further permit the devices of system 100 to communicate with remote devices 420 such as an attachment, a peripheral device, or a combination thereof through the network 106.

As previously indicated with respect to FIG. 1, the network 106 may span and represent a variety of networks and network topologies. For example, the network 106 may include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 106. Cable, Ethernet, digital subscriber line (DSL), fiber optic lines, fiber to the home (FTTH), and plain old telephone service (POTS) are examples of wired communication that may be included in the network 106. Further, the network 106 may traverse a number of network topologies and distances. For example, the network 106 may include direct connection, personal area network (PAN), local area network (LAN), metropolitan area network (MAN), wide area network (WAN), or a combination thereof.

The communication unit 416 may also function as a communication hub allowing system 100 to function as part of the network 106 and not be limited to be an end point or terminal unit to the network 106. The communication unit 416 may include active and passive components, such as microelectronics or an antenna, for interaction with the network 106.

The communication unit 416 may include a communication interface 418. The communication interface 418 may be used for communication between the communication unit 416 and other functional units or devices of system 100 or to remote devices 420. The communication interface 418 may receive information from the other functional units or devices of system 100, or from remote devices 420, or may transmit information to the other functional units or devices of the system 100 or to remote devices 420. The communication interface 418 may include different implementations depending on which functional units or devices are being interfaced with the communication unit 416. The communication interface 418 may be implemented with technologies and techniques similar to the implementation of the control interface 404.

The user interface 412 may present information generated by system 100. In aspects, the user interface 412 allows the users to interface with the system 100. The user interface 412 can allow users of the system 100 to interact with the system 100. The user interface 412 may include an input device and an output device. Examples of the input device of the user interface 412 may include a keypad, buttons, switches, touchpads, soft-keys, a keyboard, touchscreens, a mouse, or any combination thereof to provide data and communication inputs. Examples of the output device may include a display interface 414. The control unit 402 may operate the user interface 412 to present information generated by system 100. The control unit 402 may also execute the software 410 to present information generated by system 100, or to control other functional units of system 100. The display interface 414 may be any graphical user interface such as a display, a projector, a video screen, or any combination thereof.

The terms “module” or “unit” referred to in this disclosure can include software, hardware, or a combination thereof in an aspect of the present disclosure in accordance with the context in which the term is used. For example, the software may be machine code, firmware, embedded code, or application software. Also for example, the hardware may be circuitry, a processor, a special purpose computer, an integrated circuit, integrated circuit cores, or a combination thereof. Further, if a module or unit is written in the system or apparatus claims section below, the module or unit is deemed to include hardware circuitry for the purposes and the scope of the system or apparatus claims.

The modules or units in the following description of the aspects may be coupled to one another as described or as shown. The coupling may be direct or indirect, without or with intervening items between coupled modules or units. The coupling may be by physical contact or by communication between modules or units.

The above detailed description and aspects of the disclosed system 100 are not intended to be exhaustive or to limit the disclosed system 100 to the precise form disclosed above. While specific examples for system 100 are described above for illustrative purposes, various equivalent modifications are possible within the scope of the disclosed system 100, as those skilled in the relevant art will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The resulting method 300 and system 100 are cost-effective, highly versatile, and accurate, and may be implemented by adapting components for ready, efficient, and economical manufacturing, application, and utilization. Another important aspect of the present disclosure is that it valuably supports and services the historical trend of reducing costs, simplifying systems, and/or increasing performance.

These and other valuable aspects of the present disclosure consequently further the state of the technology to at least the next level. While the disclosed aspects have been described as the best mode of implementing system 100, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computer implemented method comprising:
receiving, by one or more computing devices and from a client device, a search request for information about a vehicle;
transmitting, by the one or more computing devices, the search request to decentralized entities to retrieve the information about the vehicle;
receiving, by the one or more computing devices and from the decentralized entities or a subset of decentralized entities, information about the vehicle;
generating, by the one or more computing devices, a graphical user interface (GUI) with the information about the vehicle; and
transmitting, by the one or more computing devices, the GUI to the client device for display.

2. The method of claim 1, wherein the decentralized entities can comprise: a human, a robot, an autonomous vehicle, an aerial drone, or a database.

3. The method of claim 1, wherein the information received by the one or more computing devices and from the decentralized entities or the subset of decentralized entities is received asynchronously.

4. The method of claim 1, wherein the information received by the one or more computing devices and from the decentralized entities or the subset of decentralized entities is received in real-time.

5. The method of claim 1, further comprising queuing, by the one or more computing devices, the search request prior to transmitting the search request to the decentralized entities.

6. The method of claim 1, further comprising queuing, by the one or more computing devices, the information received from the decentralized entities or the subset of the decentralized entities prior to generating the GUI with the information.

7. The method of claim 1, wherein the search request is received via a mobile software application installed on the client device.

8. A non-transitory computer readable medium including instructions for causing a computing system to perform operations comprising:
receiving, from a client device, a search request for information about a vehicle;
transmitting the search request to decentralized entities to retrieve the information about the vehicle;
receiving, from the decentralized entities or a subset of decentralized entities, information about the vehicle;
generating a graphical user interface (GUI) with the information about the vehicle; and
transmitting the GUI to the client device for display.

9. The non-transitory computer readable medium of claim 8, wherein the decentralized entities can comprise: a human, a robot, an autonomous vehicle, an aerial drone, or a database.

10. The non-transitory computer readable medium of claim 8, wherein the information received from the decentralized entities or the subset of decentralized entities is received asynchronously.

11. The non-transitory computer readable medium of claim 8, wherein the information received from the decentralized entities or the subset of decentralized entities is received in real-time.

12. The non-transitory computer readable medium of claim 8, wherein the operations further comprise queuing the search request prior to transmitting the search request to the decentralized entities.

13. The non-transitory computer readable medium of claim 8, wherein the operations further comprise queuing the information received from the decentralized entities or the subset of the decentralized entities prior to generating the GUI with the information.

14. The non-transitory computer readable medium of claim 8, wherein the search request is received via a mobile software application installed on the client device.

15. A computing system comprising:
a memory configured to store instructions; and
a processor, coupled to the memory and configured to process the stored instructions to:
receive, from a client device, a search request for information about a vehicle,
transmit the search request to decentralized entities to retrieve the information about the vehicle,
receive, from the decentralized entities or a subset of decentralized entities, information about the vehicle,
generate a graphical user interface (GUI) with the information about the vehicle, and
transmit the GUI to the client device for display.

16. The computing system of claim 15, wherein the decentralized entities can comprise: a human, a robot, an autonomous vehicle, an aerial drone, or a database.

17. The computing system of claim 15, wherein the information received from the decentralized entities or the subset of decentralized entities is received asynchronously.

18. The computing system of claim 15, wherein the information received from the decentralized entities or the subset of decentralized entities is received in real-time.

19. The computing system of claim 15, wherein the processor is further configured to queue the search request prior to transmitting the search request to the decentralized entities.

20. The computing system of claim 15, wherein the processor is further configured to queue the information received from the decentralized entities or the subset of the decentralized entities prior to generating the GUI with the information.
